(19) United States
(12) Patent Application Publication
(10) Pub. No.: US 2025/0269396 A1
(43) Pub. Date: Aug. 28, 2025

(54) SPRINKLER STRUCTURE WITH MULTI-STAGE WATER CONTROL

(71) Applicant: AQUALEAN MANUFACTURING ASSOCIATES CO., LTD., Taipei City (TW)

(72) Inventors: Pin-Hsien YU, Taipei City (TW); Kai-Yuan CHEN, Taipei City (TW)

(21) Appl. No.: 18/590,330

(22) Filed: Feb. 28, 2024

(51) Int. Cl. B05B 15/74

(52) U.S. Cl. CPC B05B 15/74

(57) ABSTRACT

Disclosed is a sprinkler structure with multi-stage water control, including: a base having an inlet; an oscillation controller disposed at the inlet for generating reciprocating oscillations using water flow; a water spray pipe connected at one end to and driven by the oscillation controller and having multiple nozzles; multiple segmented water supply chambers spaced along the extending direction of the water spray pipe, each having a water supply port communicating with multiple adjacent nozzles and forming a respective guide track in an orthogonal configuration; and multiple segmented switch controls individually mounted on the guide track of each segmented water supply chamber, each including a button, a water seal, and a water-flowing section forming a water-spraying state when in an open position and a water-closing state when in a closed position.

### CROSS-REFERENCE TO RELATED APPLICATIONS

Not applicable.

### BACKGROUND OF THE INVENTION

The present invention relates to a sprinkler; more particularly, it discloses an innovative sprinkler structure with multi-stage water control.

Conventional sprinklers typically consist of a water spray pipe with multiple nozzles. The spray pipe, controlled by an oscillation controller, generates reciprocating oscillations as water is injected under pressure to allow the sprayed water to change angles.

In response to diverse requirements, some manufacturers have incorporated a control switch on each nozzle to precisely control water spray modes. However, this established sprinkler structure has encountered several issues in use. For instance, the placement of each control switch must take into account water leakage concerns, which can result in potential leaks. As a result, if the sprinkler is configured with excessive control switches, they often experience a shortened lifespan due to low usage rates and water leakage issues. Additionally, the distribution density of the nozzles is compromised due to the need to provide sufficient space for control switch placement, resulting in poor water spray density. This is a significant engineering challenge that deserves industry attention and breakthroughs.

### SUMMARY OF THE INVENTION

The main purpose of the present invention is to provide a sprinkler structure with multi-stage water control, aiming to address technical issues in developing a more practically ideal sprinkler.

To accomplish this purpose, the main technical features of the present invention to address all of the above issues are mainly that the sprinkler comprises: a base having an inlet for introducing a water flow; an oscillation controller disposed at the inlet for generating reciprocating oscillations by using the water flow; a water spray pipe connected at one end to and driven by the oscillation controller and having multiple nozzles spaced along the extending direction of the water spray pipe; multiple segmented water supply chambers spaced along the extending direction of the water spray pipe, each having a water supply port communicating with multiple adjacent nozzles, and each correspondingly forming a guide track in an orthogonal configuration; and multiple segmented switch controls are individually mounted on the guide track of each segmented water supply chamber, each including a button, a water seal, and a water-flowing section, and each having an open position and a closed position when in use. When in the open position, the water-flowing section is aligned with the water supply port to form a water-spraying state. Conversely, when in the closed position, the water seal is aligned with the water supply port to form a water-closing state.

The main effect and advantage of the present invention lies in achieving the function of multi-stage water control in segments. Users can switch each segmented switch control to the desired open or closed position according to their needs. Consequently, when the water spray pipe is in operation, the nozzles in each segment can spray water according to their respective switch control states. This achieves the functionality and benefits of multi-stage water control, meeting diverse user requirements and demonstrating practical advancements.

Another purpose of the present invention is achieved by the additional configuration of the water spray pipe equipped with a cover at least on the side with the multiple nozzles. This cover corresponds to each button position and is further provided with segmented indicator markings, presenting an advantage and practical advancement that facilitates user recognition including the spray areas of the nozzle controlled by each button.

### BRIEF DESCRIPTION OF DRAWINGS

At FIG. 1 is an assembled perspective view of a preferred embodiment of the present invention.

FIG. 2 is an exploded perspective view of a partial component of a preferred embodiment of the present invention.

FIG. 3 is an enlarged view of FIG. 2.

FIG. 4 is a front view of a preferred embodiment of the water spray pipe.

FIG. 5 is a sectional view of FIG. 4 taken along line 5-5.

FIG. 6 is a sectional view of FIG. 5 taken along line 6-6, depicting the button in the open position.

FIG. 7 is a diagram depicting the button in the closed position.

FIG. 8 is a diagram of the segmented multi-stage water control embodiment of the present invention.

FIG. 9 is a diagram corresponding to FIG. 8, depicting the open/closed states of the segmented switch control.

### DETAILED DESCRIPTION OF THE INVENTION

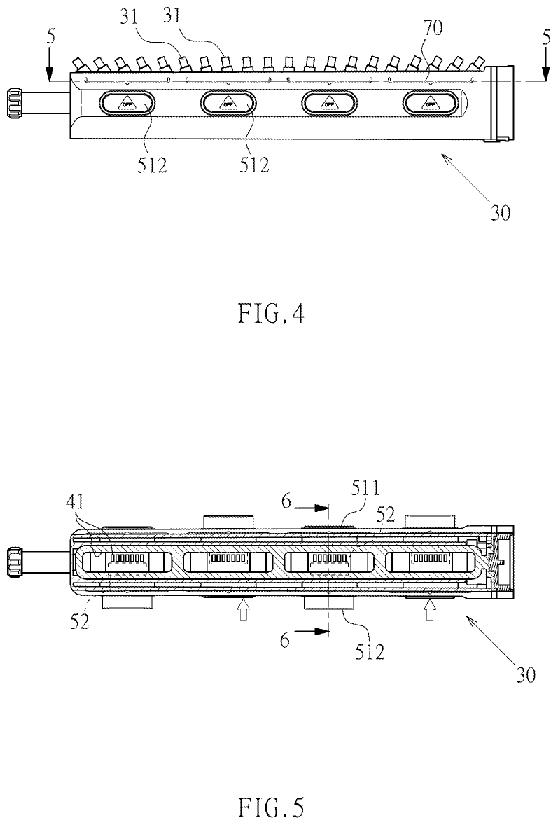

Reference is made to FIGS. 1 through 9 for a preferred embodiment of a sprinkler structure with multi-stage water control provided by the present invention. However, this embodiment is for illustrative purposes only and is not limited by this structure in the patent application.

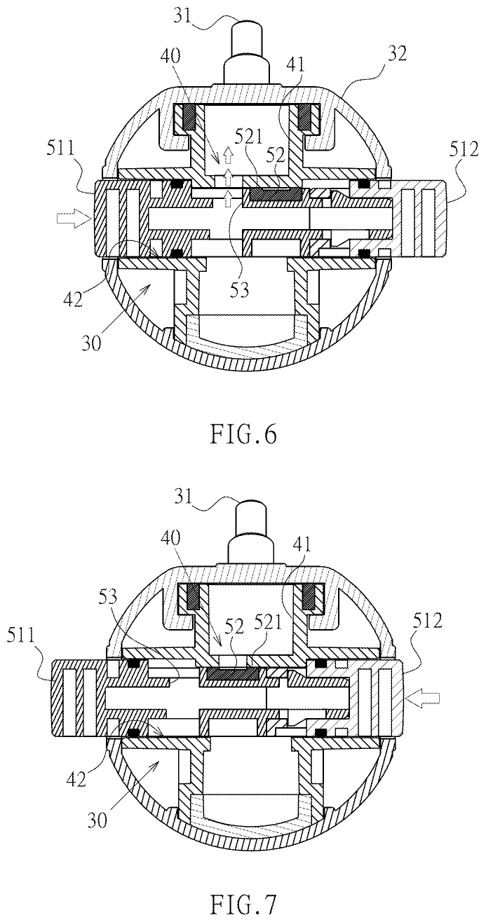

The sprinkler comprises the following components: a base 10 having an inlet 11 for introducing a water flow; an oscillation controller 20 disposed at the inlet 11 for generating reciprocating oscillations by using the water flow; a water spray pipe 30 connected at one end to and driven by the oscillation controller 20 and having multiple nozzles 31 spaced along the extending direction of the water spray pipe 30; multiple segmented water supply chambers 40 spaced along the extending direction of the water spray pipe 30, each having a water supply port 41 communicating with multiple adjacent nozzles 31, and each correspondingly forming a guide track 42 in an orthogonal configuration; and multiple segmented switch controls 50 are individually mounted on the guide track 42 of each segmented water supply chamber 40, each including a button (described in more detail below), a water seal 52, and a water-flowing section 53, and each having an open position and a closed position when in use. When in the open position, as shown in FIG. 6, the water-flowing section 53 is aligned with the water supply port 41 to form a water-spraying state. Conversely, when in the closed position, as shown in FIG. 7, the water seal 52 is aligned with the water supply port 41 to form a water-closing state. Through this design, the sprinkler achieves the functionality of multi-stage water control.

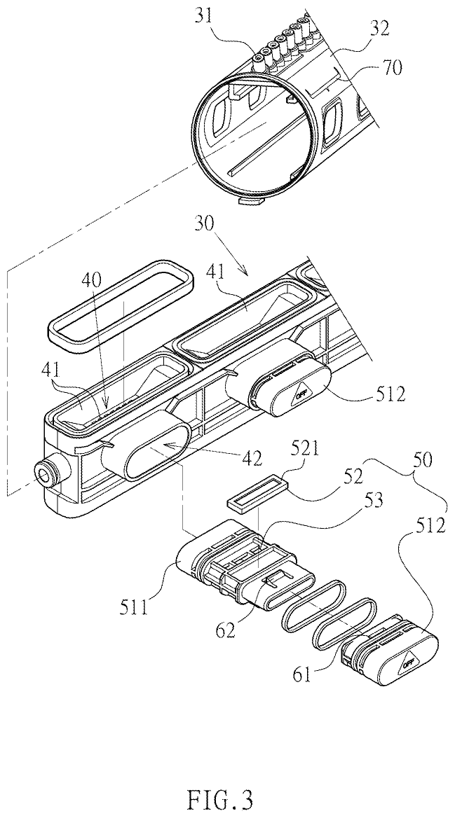

As shown in FIG. 3, in this embodiment, the button and the segmented switch control 50 are combined and positioned by a cooperating notch 61 and hook 62.

As shown in FIG. 3, in this embodiment, the button has a double-headed configuration with respect to the segmented switch control 50, including a first end button 511 and a second end button 512 positioned apart from each other. When the user presses the first end button 511, it forms the open position, as shown in FIG. 6. Conversely, when the user presses the second end button 512, it forms the closed position, as shown in FIG. 7.

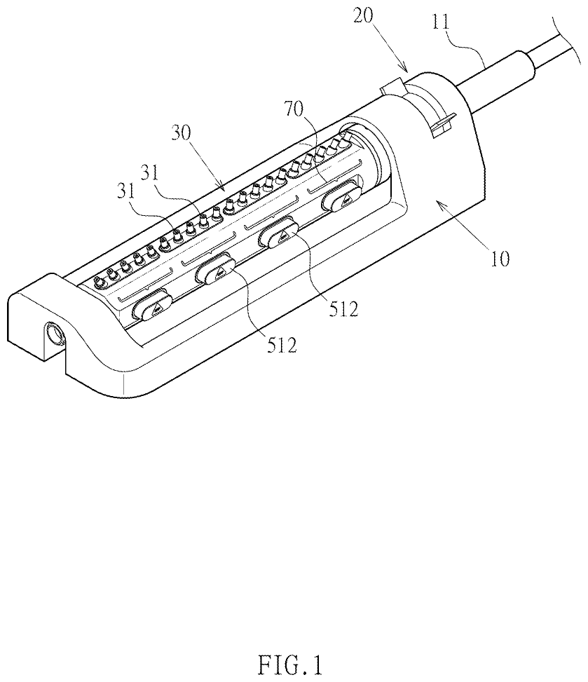

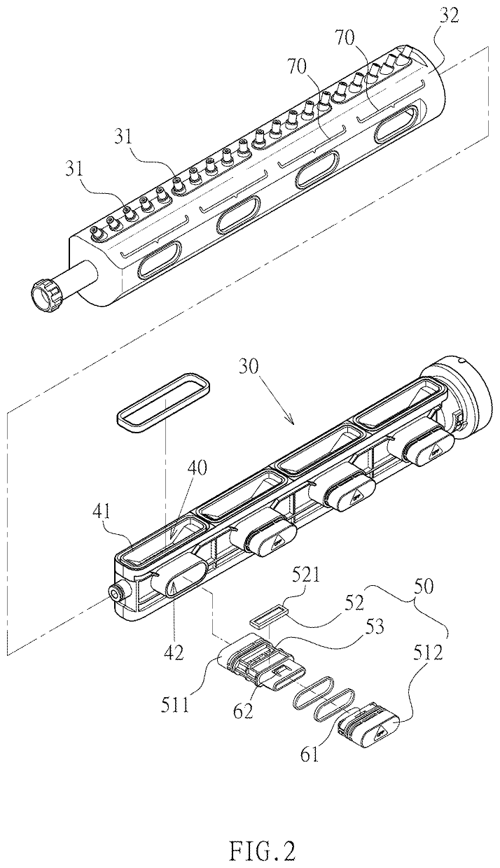

As shown in FIGS. 2 and 6, in this embodiment, the water spray pipe 30 is equipped with a cover 32 at least on the side with the multiple nozzles 31.

As shown in FIG. 2, in this embodiment, the cover 32 corresponds to each button position and is further provided with segmented indicator markings 70 to facilitate user recognition including the spray areas of the nozzle 31 controlled by each button.

Wherein, the flow passage cross-sectional area of the water supply port 41 of each segmented water supply chamber 40 is greater than the total cross-sectional area of the communicating nozzles 31.

As shown in FIGS. 3 and 7, in this embodiment, the water seal 52 forms a protruding peripheral edge 521. The protruding peripheral edge 521 is aligned with the periphery of the water supply port 41 to form a water-sealing state.

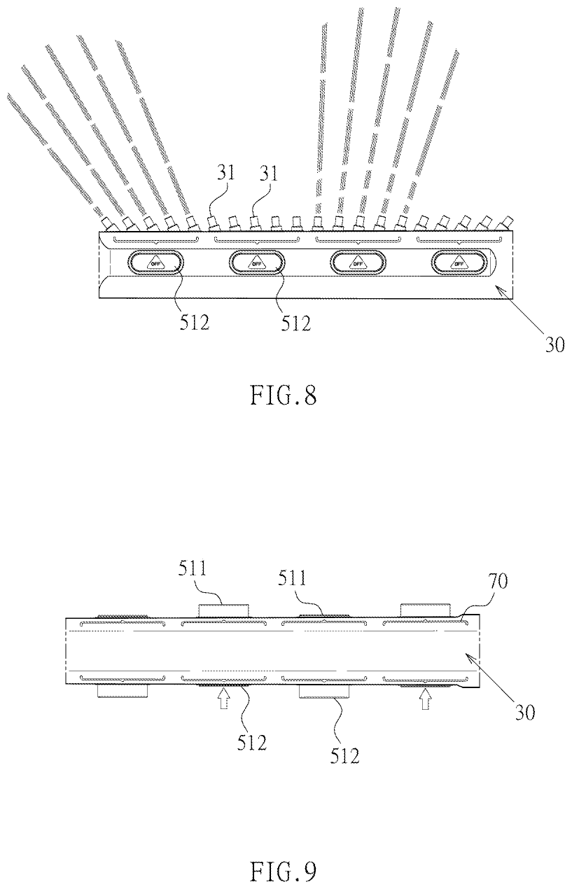

By the above structural configuration and technical features, the multi-stage water control sprinkler of the present invention achieves a unique configuration by having each segmented water supply chamber 40 with the water supply port 41 connected to the multiple adjacent nozzles 31. Thus, the multiple adjacent nozzles 31 form a water control segment, and each water control segment can be controlled in its water supply open/closed state by the corresponding segmented switch control 50. In a practical application, as shown in FIGS. 8 and 9, users can switch each segmented switch control 50 to the desired open or closed position. Thus, when the water spray pipe 30 sprays water, the nozzles 31 in each segment can spray water according to the previously mentioned switch control state, thereby achieving the functionality and advantages of multi-stage water control. The term “multi-stage water control” herein includes water modes such as all segments, middle segments, or end segments of the water spray pipe 30, and should satisfy diverse user needs.

1. A sprinkler structure with multi-stage water control, comprising:
a base having an inlet for introducing a water flow, an oscillation controller disposed at the inlet for generating reciprocating oscillations using the water flow;
a water spray pipe connected at one end to and driven by the oscillation controller and having multiple nozzles spaced along the extending direction of the water spray pipe;
multiple segmented water supply chambers spaced along the extending direction of the water spray pipe, each having a water supply port communicating with multiple adjacent nozzles, and each forming a respective guide track in an orthogonal configuration; and
multiple segmented switch controls individually mounted on the guide track of each segmented water supply chamber, each including a button, a water seal, and a water-flowing section, and each having an open position and a closed position when in use, forming a water-spraying state with the water-flowing section aligned with the water supply port when in the open position, and forming a water-closing state with the water seal aligned with the water supply port when in the closed position.

2. The sprinkler structure according to claim 1, wherein the button and the segmented switch control are combined and positioned by a cooperating notch and hook.

3. The sprinkler structure according to claim 2, wherein the button has a double-headed configuration with respect to the segmented switch control, including a first end button and a second end button positioned apart from each other, and when the user presses the first end button, it forms the open position, and when the user presses the second end button, it forms the closed position.

4. The sprinkler structure according to claim 1, wherein the water spray pipe is equipped with a cover at least on the side with the multiple nozzles.

5. The sprinkler structure according to claim 4, wherein the cover corresponds to each button position and is further provided with segmented indicator markings to facilitate user recognition including the spray areas of the nozzle controlled by each button.

6. The sprinkler structure according to claim 1, wherein the flow passage cross-sectional area of the water supply port of each segmented water supply chamber is greater than the total cross-sectional area of the communicating nozzles.

7. The sprinkler structure according to claim 1, wherein the water seal forms a protruding peripheral edge, which is aligned with the periphery of the water supply port to form a water-sealing state.
